(19) United States
(12) Patent Application Publication
(10) Pub. No.: US 2010/0324984 A1
(43) Pub. Date: Dec. 23, 2010

(54) VENDING MACHINE PRIZE REDEMPTION AND MARKETING SYSTEM

(76) Inventor: Aaron Pelto, Cave Creek, AZ (US)

Correspondence Address: JUNEAU PARTNERS, 333 N Fairfax St., Suite 305, ALEXANDRIA, VA, 22301, US

(21) Appl. No.: 12/490,305

(22) Filed: Jun. 23, 2009

(51) Int. Cl. G06Q 30/00

(52) U.S. Cl. 705/14.25

(57) ABSTRACT

The present invention relates to bulk vending machines that sell items in combination with a redemption certificate for points that can be redeemed at a website for premium prizes by a customer, and for collection of marketing information by the seller.

### CROSS REFERENCE TO RELATED APPLICATIONS

n/a

### STATEMENT REGARDING FEDERALLY SPONSORED RESEARCH

n/a

### NAMES OF PARTIES TO A JOINT RESEARCH AGREEMENT

n/a

### REFERENCE TO A SEQUENCE LISTING

n/a

### BACKGROUND

1. Field of the Invention

The present invention relates to bulk vending machines that sell items, such as capsule toys, and in particular to bulk vending machines that sell items in combination with a redemption certificate for points that can be redeemed at a website for premium prizes by a customer, and for collection of marketing information by the seller.

2. Description of the Prior Art

Recent Product manufacturers and retailers have always been interested in finding new ways to better attract and hold customers. One method commonly used, particularly by national brands, is to sponsor some form of sweepstakes event to differentiate themselves from a competitor and help build brand awareness. In addition to sweepstakes type attractions, others have tried to integrate gaming concepts into the retail environment to help attract customers.

The psychological attraction to the dream of winning prizes in a contest is strong and can be used to encourage compliance with marketing surveys.

Some have incorporated a game of chance into the retail environment prior to the check stand. A method of randomly determining the value of a coupon presented to a coupon validator machine by a shopper prior to proceeding to the checkout counter is disclosed in U.S. Pat. No. 5,368,129 granted Nov. 29, 1994 to Van Kohom. The coupon validator prints the randomized discount amount on the coupon which is returned to the shopper for use at the checkout counter.

Others have incorporated a game of chance at the check stand. U.S. Pat. No. 4,854,590 granted Aug. 8, 1989 to Joliff, et al. discloses a microprocessor based system for connection to a cash register and activated upon each ring-up of a valid sale. The system randomly determines if the customer has won, and if so, what amount has been won.

U.S. Pat. No. 6,634,550 granted Oct. 21, 2003 to Walker, et al. discloses a virtual slot machine display device tied to a point of sale terminal The game presentation includes images of products and indicates what has been won, such as a free product, a discount on a product selected for purchase, a coupon, or an upsell offer.

U.S. Pat. No. 6,048,268 granted Apr. 11, 2000 to Humble discloses a promotional game operating in conjunction with a point of sale terminal displaying the image of a game card. The game card has areas which appear covered and are exposed by customer selection similar to that of a scratch ticket game. The processor selects prizes and varies the odds of winning a prize as a function of the identity of products purchased by the participant or their dollar value.

U.S. Pat. No. 4,157,829 granted Jun. 12, 1979 to Goldman, et al. discloses an instant lottery game for a centrally controlled remote vending machine. Upon the receipt of a wager of a proper amount, the central computer generates random indicia to be matched with the patron's pre-selected indicia to determine and pay a cash prize amount. There is no vending of a product, just a lottery game.

U.S. Pat. No. 4,213,524 granted Jul. 22, 1980 to Miyashita, et al. discloses an automatic vending machine with lottery bonus. A plurality of electric lamps arranged geometrically on a front panel of the machine and a lamp control circuit for lighting the lamps successively and repeatedly in response to a vending signal produces a winning signal for discharging an extra article as a free addition if the light spot is stopped at a predetermined lamp having a lucky number.

U.S. Pat. Publication No. 20030186732 filed Oct. 2, 2003 by Viglione discloses a vending machine offering a game of chance or skill. A game is played for a predetermined prize only after payment and selection of a product.

U.S. Pat. Publication No. 20020107610 filed Aug. 8, 2002 by Kaehler, et al. discloses a vending machine randomly dispensing prize items, in addition to selected items,

U.S. Pat. No. 5,007,641 granted Apr. 16, 1991 to Seidman and U.S. Pat. No. 5,080,364 granted Jan. 14, 1992 to Seidman discloses a promotional game on an automated redemption machine. Prizes are awarded at random to patrons who present appropriate barcoded symbols from coupons or product packages bearing a particular code.

### SUMMARY OF THE INVENTION

Provided herein by this description and claims, is a bulk vending machine for selling items in combination with a redemption certificate for points that can be redeemed at a website for premium prizes by a customer, and for collection of marketing information by the seller, comprising: storage and vend actuation means for a plurality of items, currency validation means for authenticating a customer's payment to provide credit value toward the purchase of an item, a redemption certificate associated with the item, said certificate having security means for validating the certificate in an online registration system, said online registration system comprising a server computer having a database for inputting redemption certificate information and associating said certificate information with customer account information collected during registration, said certificate information comprising points that are stored within the customer account information, said database in operative association with an online point redemption database, wherein customer appreciation prizes are awarded based upon the level of points redeemed by the customer, and wherein marketing information is generated and stored on the server from the combination of customer account information, redemption certificate information, and point redemption database information.

In a preferred embodiment, the item is a toy, such as light up toys and glow sticks.

In another preferred embodiment, the vending machine further comprises wherein the marketing information includes time of sale, location of sale, frequency of redemption, and information concerning the prizes redeemed.

In another preferred embodiment, the vending machine further comprises wherein the prizes are high value electronics including mp3 players, and console gaming stations.

In another preferred embodiment, there is provided a method for increasing the sales of items offered in a bulk vending machine, comprising: packaging the item in combination with a redemption certificate for points, said certificate redeemable at a website for premium prizes by a customer, and collecting marketing information obtained during the customer's account registration and redemption activities, wherein a plurality of items are stored and offered for sale from a bulk vending machine, and wherein a redemption certificate is packaged with the item, said redemption certificate having security means for validating the certificate in an online registration system, said online registration system comprising a server computer having a database for inputting redemption certificate information and associating said certificate information with customer account information collected during registration, said certificate information comprising points that are stored within the customer account information, said database in operative association with an online point redemption database, wherein customer appreciation prizes are awarded based upon the level of points redeemed by the customer, and wherein marketing information is generated and stored on the server from the combination of customer account information, redemption certificate information, and point redemption database information.

In another preferred embodiment, the method further comprises wherein the marketing information includes time of sale, location of sale, frequency of redemption, and information concerning the prizes redeemed.

In another preferred embodiment, the method further comprises wherein the prizes are high value electronics including mp3 players, and console gaming stations.

In another preferred embodiment, a vending machine marketing system is provided, which comprises: a server subsystem for serving content, via a communication network, to a user computer, and for receiving one or both of data and commands from the user computer; a registration subsystem for verifying and then registering the user, wherein the verifying includes determining a validity of a redemption certificate obtained with the purchase of a light up toy or glow in the dark novelty from a vending machine, and wherein the registering is for allowing the user to access a restricted portion of the vending machine marketing system; and a prize redemption subsystem for providing a user with a delivered prize based upon redemption of points associated with the redemption certificate.

In another preferred embodiment, a vending machine marketing system is provided, which comprises: a storage subsystem for storing data relating to a plurality of registration codes, each of the registration codes corresponding to one of a plurality of redemption certificates sold with an item from a vending machine; a server subsystem for serving content, via a communication network, to a user computer, and for receiving one of the registration codes transmitted from the user computer via one or both of the communication network and an additional communication network; a registration subsystem for verifying the one of the registration codes against the data relating to the plurality of registration codes, and subsequently registering the user in the system after the verifying; and a prize redemption subsystem for providing a user with a delivered prize based upon redemption of points associated with the redemption certificate.

In another preferred embodiment, a computer readable medium is provided for storing computer readable program code for performing the methods claimed or disclosed herein by utilizing a computer system as claimed or disclosed herein.

### BRIEF DESCRIPTION OF THE FIGURES

FIG. 1 is a photographic representation of a web-based glow machine.

FIG. 2 is a photographic representation of an original glow machine.

FIG. 3 is a a schematic block diagram of a current embodiment of the system and its interactions with some external entities.

FIG. 4 shows a schematic diagram of a possible hardware implementation of an embodiment of the invention.

FIG. 5 shows a schematic diagram of a more complex hardware implementation of another embodiment of the invention.

FIG. 6 shows a manner of a user registering with the System of the current embodiment for utilizing the System features.

FIG. 7 shows a block diagram of another embodiment of the system and its interactions with some external entities.

### DETAILED DESCRIPTION OF THE PREFERRED EMBODIMENTS

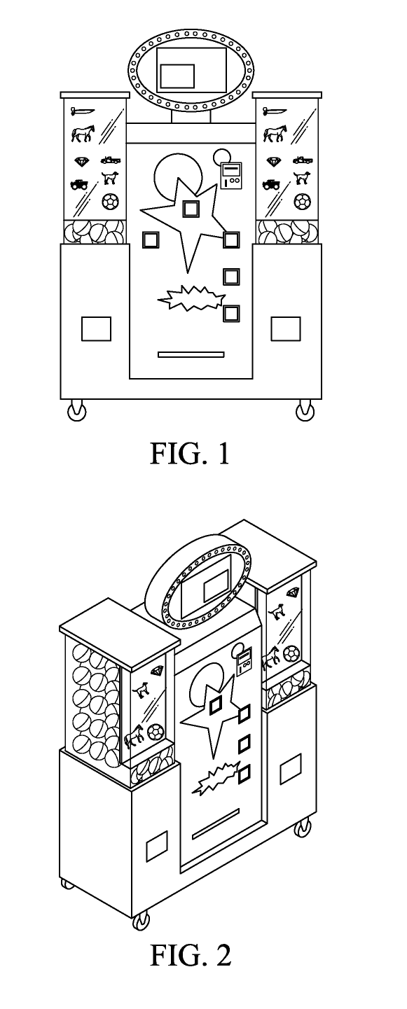

A conventional vending machine for dispensing a variety of items is used. FIGS. 1 and 2 show a vending machine selling encapsulated light up toys and glow in the dark novelties. A customer will normally deposit coins or bill into the vending machine at a coin entry slot or bill entry slot for validation by a corresponding coin validator or bill validator within the machine. The amount of currency validated by the machine may be shown on a display. When sufficient currency has been deposited to enable the machine to vend one of its products, corresponding selection buttons are enabled to permit the customer to make his selection and activate the vending of the selected product through the delivery chute. Any excess accumulated credit value is returned to the patron by a coin changer through the coin return.

Most of today's vending machines have a standardized communication interface called MDB (Multi-Drop Bus) to enable the various machine components to communicate with one another even though they may have been produced by separate manufacturers. The MDB protocol is maintained and managed by the National Association For Automated Merchandising (NAMA) and is here incorporated by reference. MDB is an RS-232 derivative having an optically coupled interface and a master/multi-slave topology. It uses a pair of 6-pin Molex Mini-Fit Jr. connectors to carry both communications and power. Its protocol allows the controller to know when coins have been received by the coin validator, to know when bills have been received by the bill validator, to know how full the coin changer is, and to command the coin changer to return any excess credit to the customer when the vend cycle has been completed. Part of the MDB protocol includes identification of up to 16 different coin or token types.

The current system functions basically as follows: A consumer purchases an encapsulated light up toy or glow in the dark novelty from a vending machine. The toy or novelty is contained within a plastic capsule, and the container includes a redemption certificate. The redemption certificate can take the form of a tag, piece of paper, other indicator or storage device, having a registration code and directions for directing the customer to a web site address. The customer/user can load the System web site using the web address in a browser application running on the user's computer, and then enter the registration certificate code. Each registration certificate can have the same, or different, quantities of points associated with it. In preferred embodiments, the customer is directed to establish a customer account. Marketing information, taken from the registration code process and/or the customer account formation process, is collected and provided to the vendor. Once the customer account reaches pre-determined point totals, the customer may redeem the points for prizes, which are then shipped to the customer using the address information provided by the customer.

The System of the current embodiment utilizes a server subsystem including a web server subsystem for generating both dynamic and static web pages as is known in the art, and for receiving data and./or commands from the user computer. One or more databases support the functioning of this server subsystem. The web server utilizes various scripting or other executable programs for providing dynamic content to the user's computer, which is attached to the web server via some computer network, such as the Internet, for example. The web server can also utilize various animated motion programs, such as a Flash program, java scripts, etc., to provide dynamic content to the user.

In order to provide the customer with the redemption certificate, a ticket printer, e.g. a barcoded ticket printer, such as the PSA-66-ST by FutureLogic, may be used to produce coded redemption certificates that contain codes to redeem prizes at the web glow machine website. Once the customer, receives the certificate and enters the information into the web interface, a customer account is created and marketing information is collected. The customer account holds the points accumulated from the customer's certificate entries, which can then be redeemed at various levels for increasingly valuable prizes, such as mp3 players, video game consoles, and so forth.

Information from each machine is transmitted on a regular basis from each of the machines over an internet or intranet link to a remote database. Code printing and barcode printing software, such as that available from Avery Dennison Corporation, provides serialization capability for 1D and 2D barcodes. When barcodes are entered into a control computer, it is validated and stored in its local database. If the serial number has been previously read, then it is not validated.

In one embodiment, the certificate may take the form of an RFID tag. RFID tags compliant with the EPC96 standard carry a product identification code as well as a product serial number. The data read from an RFID tag is treated the same as previously described for the serialized code or barcode style redemption certificate.

The vending machine marketing system is comprised of a server subsystem for interacting with the customers/users via a user computer being operated by the user. The server subsystem can utilize a server, for serving content, including web pages, data, commands, and/or programs, for example, to the user computer. In addition, the server subsystem can include a reception subsystem, for receiving information and commands from the users. Alternatively, the server and reception subsystem might be combined into a single computer application, such as a commercially available web server, for example, running on one or more computers. The current system will utilize commercially available applications to implement much of the server subsystem.

The vending machine marketing system also comprises a Storage Subsystem, for storing system data, user IDs and passwords, toy registration codes, personalized user information, etc. utilized by the various subsystems. The Storage Subsystem of the current system will utilize a commercially available database application running on commercially available hardware, for example.

A Registration Subsystem is used within the vending machine marketing system for registering the user and the user's toy into the system. In one embodiment, this can provide the user with access to restricted portions of the system. The Registration Subsystem may utilize its own dedicated application and hardware, or could be combined with or share the Server Subsystem applications and/or hardware. The registration subsystem examines the registration code against stored data relating to a plurality of registration codes.

A Prize Redemption Subsystem generates and/or provides the redemption data to be served by the server to the users for use in displaying the redemption information on the users computers. This data is obtained and/or derived from data stored in the Storage Subsystem.

The Subsystems may utilize unique applications and/or hardware, or may be combined with one or more of the other Subsystems and/or the Server Subsystem applications and hardware.

Referring now to the figures, FIG. 1 shows how the capsule toys having the glow in the dark feature are displayed, and how the standard vending machine features are also included, such as money slot, vend buttons, instructions, toy dispensing trough, and display of internet certificate instructions.

FIG. 2 shows an original glow machine displaying the capsule toys that have the glow in the dark feature are displayed, and the standard vending machine features, such as money slot, vend buttons, instructions, and toy dispensing trough.

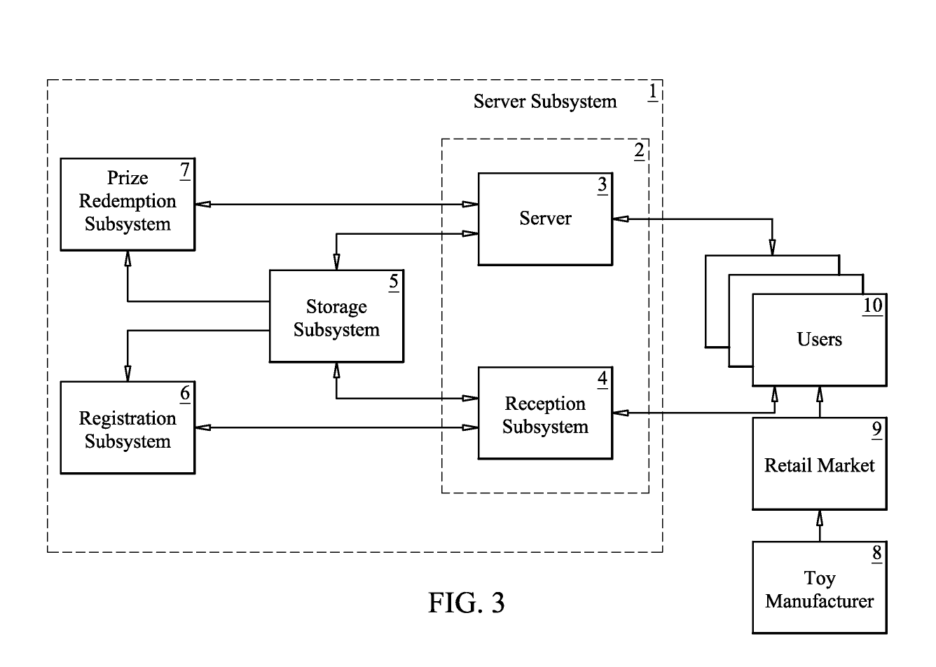

FIG. 3 Shows a top-level block diagram of the vending machine marketing system, interacting with various users 10. The users 10 should have previously purchased and registered one or more toys from a Vending Machine 9, who obtained the toys from a manufacturer 8, or via a distributor.

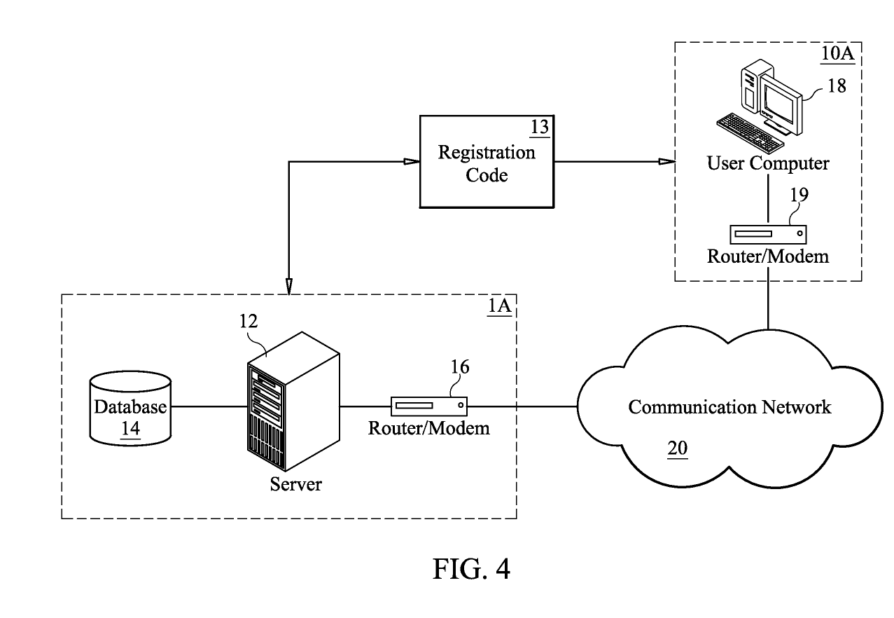

FIG. 4 shows an example implementation of the vending machine marketing system, in one of its simplest forms. The system 1A comprises a server 12, a database 14, and a router/modem 16 to connect to a public communications network 20. A user 10A, utilizing a workstation 18, is also connected to the communications network via a router and/or modem 19, for example. In this implementation, the server 12, along with the database 14 and router/modem 16 and the appropriate software, implement all of the subsystem functions of the System by executing various application programs on the server 12 hardware, for example. Of course, the system 1A may also support many additional users in a manner similar to that shown for user 10A, for example.

The current embodiment can utilize the Internet as the public communications network. However, other communications networks could be utilized, such as telephone networks, cellular networks, dedicated networks, cable TV networks, power lines, etc. Furthermore, combinations of these networks can be used for various functions. However, because of the ubiquitous nature of the Internet, a solution utilizing that diverse network (which can utilize many individual communications networks) is utilized in the current embodiment.

Furthermore, the System might also utilize a private communication network for at least part of the system. For example, the Registration Subsystem 6 of FIG. 3 might be connected to a private computer network located at the retail store 8, where the user might register the toy, for example, as discussed in more detail below. Alternatively, the toy might automatically be registered at the time of purchase (e.g., by scanning a code at the register, for example), and thus not require any user interaction at all beyond purchasing the toy. Or the user might send in a registration card to implement registration, as another example.

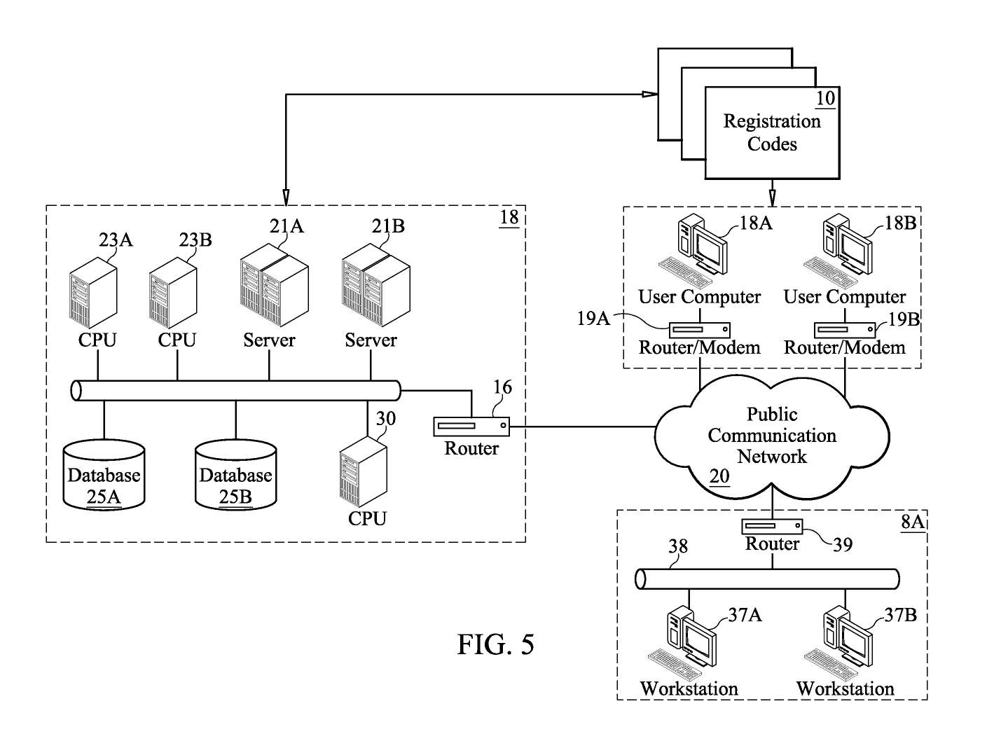

FIG. 5 shows a more complex implementation 1B of the System. In this example system 1B, a plurality of servers 21A-21n can be utilized to implement the server subsystem 2 functions of FIG. 3. Furthermore, a plurality of CPUs 23A-23n can be utilized to implement the Virtual World Providing Subsystem 7 functions of FIG. 3. A plurality of database storage devices 25A-25n may be used to implement the Storage Subsystem 5 functions of FIG. 3. And a CPU 30 can be used to implement the Registration Subsystem 6 functions of FIG. 3, for example. Finally, a router 29 can be used to connect to the Public Communications Network 20.

Note that, although FIG. 5 shows multiple servers 21A-n, multiple CPUs 23A-n, and multiple databases 25A-n, any of these might be implemented on one or more shared computers in various configurations, executing one or more computer program applications, as desired. As the number of users supported by the system 1C grows, additional hardware can be added to increase the capacity of the system, as necessary, in a manner similar to that shown in the Figure.

Continuing with FIG. 5 showing the more complex implementation 1B, a plurality of users can be supported in various configurations. For example, a plurality of users 10B operating single workstations 18A-18n, individually connected to the public communications network 35, can be supported. Furthermore, complex user networks can also be supported. Retailers and or Toy Manufacturers might also have access to the system, as represented by the example shown in 8A, should an online-ordering system be implemented for selling toys. Of course, alternate implementations are also possible, depending on the types and number of users and/or retailers being supported, and also depending on the state-of-the-art computer technology.

In one embodiment, the System uses an Apache web server running in a Linux environment. For webserver hardware, an Intel 2 Ghz+CPUs with 2 GB RAM running Gentoo linux with the appropriate extensions (e.g., mod_php4 and mod_perl) can be utilized. The server will serve flash content to a web browser running a web browser application using PHP, Perl, and actionscript, and flash plugins. A MySQL database application will also be utilized for the storage subsystem.

The client (user) side Flash application make the calls to a number of PHP files. These PHP files then “interface” with the MySQL database to obtain the necessary data. All are served by the Apache web server, which can serve HTML, XML, along with the appropriate flash and other content.

This is effectively a 3 layer type of setup: Flash layer⇄PHP layer (this handles requests to the back end)⇄MySQL database, as shown in FIG. 1A. FIG. 1B shows the interaction between the client (user) and server subsystem data flows in more detail. A dedicated database server running MySQL on a dedicated computer running the Gentoo linux OS can be used in the current system.

A secure Apache SSL server can be utilized for the registration subsystem, likely sharing the computer with the other Apache server.

One implementation of the current system utilizes an Apache Secure Web server for serving files over secure connection (HTTPS, SSL mode), and an Apache Web server for serving files over regular HTTP.

User registration is a flash application with PHP backend. The user registration uses a form-driven flash application which validates the registration code and creates a user account within the system. A form driven flash application is designed for guiding the user through the registration and account creation process, and validating the registration code.

An authentication/login process is a flash application validating user credentials on the server side and spawning an API core in case of validation. It also has module designed for password retrieval based on collected user information, and currently passes user data to a client side API, and may in the future pass user data and a generated encryption key for a current session to a client side API.

To ensure users privacy, prevent cheating and preserve validity/authenticity of information, additional security layers can be designed which encrypts all data being passed back and forth in-between parts of the APIs (client/server).

The chosen Encryption technique of the current embodiment may be a modification of TEA routines, using a Feistel cypher with 128 bit key. Keys are generated at the login stage and securely passed to client side via HTTPS, after which the adoption centre spawns the client side API and passes the encryption data specific for the session. Additional measures which can be taken to prevent cheating and maintain data coherency include using different permutations of the original key for every data transmission.

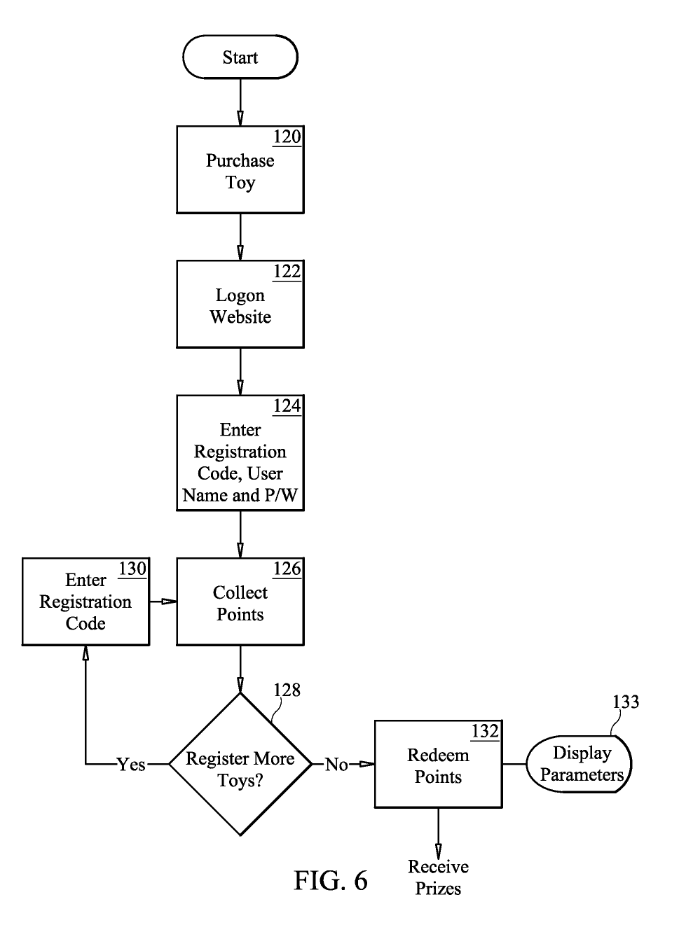

Referring now to FIG. 6, the current system functions basically as follows: A consumer purchases an encapsulated light up toy or glow in the dark novelty from a vending machine. The toy or novelty is contained within a plastic capsule, and the container includes a redemption certificate. The redemption certificate can take the form of a tag, piece of paper, other indicator or storage device, having a registration code and directions for directing the customer to a web site address. The customer/user can load the System web site using the web address in a browser application running on the user's computer, and then enter the registration certificate code. Each registration certificate can have the same, or different, quantities of points associated with it. In preferred embodiments, the customer is directed to establish a customer account. Marketing information, taken from the registration code process and/or the customer account formation process, is collected and provided to the vendor. Once the customer account reaches pre-determined point totals, the customer may redeem the points for prizes, which are then shipped to the customer using the address information provided by the customer.

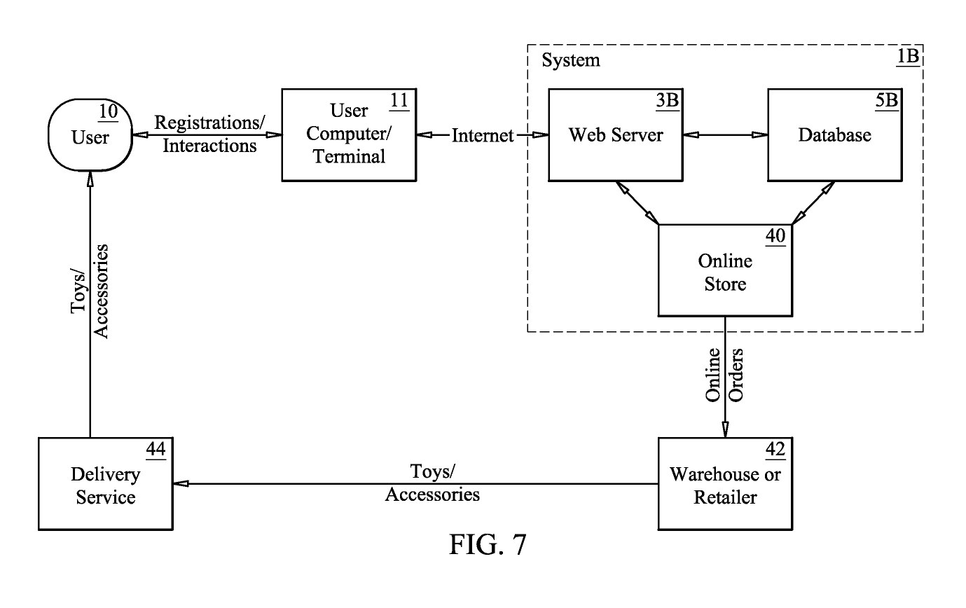

Referring now to FIG. 7, the Prize Redemption Subsystem is shown where the customer/user redeems his or her points within the online store 40. The store then communicates with warehouse 42 and delivery service 44 to forward prizes to the customer.

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable Equivalents.

What is claimed is:

1. A bulk vending machine for selling items in combination with a redemption certificate for points that can be redeemed at a website for premium prizes by a customer, and for collection of marketing information by the seller, comprising: storage and vend actuation means for a plurality of items, currency validation means for authenticating a customer's payment to provide credit value toward the purchase of the item, a redemption certificate associated with the item, said certificate having security means for validating the certificate in an online registration system, said online registration system comprising a server computer having a database for inputting redemption certificate information and associating said certificate information with customer account information collected during registration, said certificate information comprising points that are stored within the customer account information, said database in operative association with an online point redemption database, wherein customer appreciation prizes are awarded based upon the level of points redeemed by the customer, and wherein marketing information is generated and stored on the server from the combination of customer account information, redemption certificate information, and point redemption database information.

2. The vending machine of claim 1, further comprising wherein the items comprise encapsulated toys.

3. The vending machine of claim 1, further comprising wherein the marketing information includes time of sale, location of sale, frequency of redemption, and information concerning the prizes redeemed.

4. The vending machine of claim 1, further comprising wherein the prizes are high value electronics including mp3 players, and console gaming stations.

5. A method for increasing the sales of items offered in a bulk vending machine, comprising: packaging the item in combination with a redemption certificate for points, said certificate redeemable at a website for premium prizes by a customer, and collecting marketing information obtained during the customer's account registration and redemption activities, wherein a plurality of items are stored and offered for sale from a bulk vending machine, and wherein a redemption certificate is packaged within the item, said redemption certificate having security means for validating the certificate in an online registration system, said online registration system comprising a server computer having a database for inputting redemption certificate information and associating said certificate information with customer account information collected during registration, said certificate information comprising points that are stored within the customer account information, said database in operative association with an online point redemption database, wherein customer appreciation prizes are awarded based upon the level of points redeemed by the customer, and wherein marketing information is generated and stored on the server from the combination of customer account information, redemption certificate information, and point redemption database information.

6. The method of claim 5, further comprising wherein the item is an encapsulated toy.

7. The method of claim 5, further comprising wherein the marketing information includes time of sale, location of sale, frequency of redemption, and information concerning the prizes redeemed.

8. The method of claim 5, further comprising wherein the prizes are high value electronics including mp3 players, and console gaming stations.

9. A vending machine marketing system, which comprises: a server subsystem for serving content, via a communication network, to a user computer, and for receiving one or both of data and commands from the user computer; a registration subsystem for verifying and then registering the user, wherein the verifying includes determining a validity of a redemption certificate obtained with the purchase of an item from a vending machine, and wherein the registering is for allowing the user to access a restricted portion of the vending machine marketing system; and a prize redemption subsystem for providing a user with a delivered prize based upon redemption of points associated with the redemption certificate.

10. A vending machine marketing system, which comprises: a storage subsystem for storing data relating to a plurality of registration codes, each of the registration codes corresponding to one of a plurality of redemption certificates sold with an item from a vending machine; a server subsystem for serving content, via a communication network, to a user computer, and for receiving one of the registration codes transmitted from the user computer via one or both of the communication network and an additional communication network; a registration subsystem for verifying the one of the registration codes against the data relating to the plurality of registration codes, and subsequently registering the user in the system after the verifying; and a prize redemption subsystem for providing a user with a delivered prize based upon redemption of points associated with the redemption certificate.

11. A computer readable medium for storing computer readable program code for performing the method of claim 5 by utilizing a computer system of claim 9.
